(19) United States
(12) Patent Application Publication
(10) Pub. No.: US 2013/0032135 A1
(43) Pub. Date: Feb. 7, 2013

(54) Apparatuses and Methods for Determining and Changing the Orientation of Solar Energy Capture Devices

(71) Applicants: Tamsyn Peronel WATERHOUSE, San Francisco, CA (US); Daniel Larner, San Jose, CA (US); Ken Krieger, Jackson, WY (US); Ross Koningstein, Atherton, CA (US)

(72) Inventors: Tamsyn Peronel WATERHOUSE, San Francisco, CA (US); Daniel Larner, San Jose, CA (US); Ken Krieger, Jackson, WY (US); Ross Koningstein, Atherton, CA (US)

(73) Assignee: Google Inc., Mountain View, CA (US)

(21) Appl. No.: 13/204,060

(22) Filed: Aug. 5, 2011

(51) Int. Cl. F24J 2/40; G01C 9/00

(52) U.S. Cl. 126/572; 33/365

(57) ABSTRACT

An apparatus for capturing solar energy can include a solar energy capture device having an orientation plane and a sensor configured to determine a direction of gravity relative to a sensor plane. The solar energy capture device is configured to rotate about a pitch axis and a roll axis. The sensor plane can have an orientation that is fixed relative to the solar energy capture device. The orientation plane can he offset from the roll axis.

### BACKGROUND OF THE INVENTION

1. Field of the Invention

The present invention is generally directed to apparatuses and methods for determining an orientation of an object and, more particularly, to apparatuses and methods for determining an orientation of a solar energy capture device using a sensor.

2. Background

For numerous reasons—including lowering the concentrations of greenhouse gases, strengthening the ozone layer, reducing global warming effects, and obtaining a sustainable source of energy—energy sources other than fossils fuels are becoming more popular. One common alternative energy source is solar energy.

There are two common systems for generating electricity from solar energy: a thermal system and a photovoltaic system. In a thermal system, a mirror assembly reflects sunlight onto a receiver. The receiver, in turn, may heat a fluid or gas. In some thermal systems, the receiver heats the fluid or gas to power a turbine to create electricity, for example, by turning a fluid into a gas. In other thermal systems, the receiver can simply heat the fluid or gas for process heat applications. In photovoltaic systems, a photovoltaic panel converts sunlight into electricity. In both systems, the orientation of the solar energy capture device—the mirror assembly in a thermal system or the photovoltaic panel in a photovoltaic system, for example—should continuously change as the position of the sun changes. For example, as the sun moves, the orientation of the mirror assembly needs to change to keep the reflected light focused on the receiver. In photovoltaic systems, the orientation of the photovoltaic panel should be changed to ensure that the panel is orthogonal to the direction of the sunlight to achieve peak efficiency.

One type of system for changing the orientation of solar energy capture devices is an azimuth-elevation system. In an azimuth-elevation system, the solar energy capture device can rotate about a vertical azimuth axis and an elevation axis that is perpendicular to the azimuth axis. However, rotation about the azimuth axis cannot be detected by many sensing devices due to azimuthal symmetry, as further described below.

Accordingly, there is a need for apparatuses for determining and changing the orientation of a solar energy capture device and for methods of determining and changing the orientation of the solar energy capture device.

### BRIEF SUMMARY OF THE INVENTION

In one embodiment, an apparatus for capturing solar energy includes a solar energy capture device having an orientation plane, and a sensor configured to determine a direction of gravity relative to a second plane. The solar energy capture device is configured to rotate about a pitch axis and a roll axis. The orientation of the second plane is fixed relative to the orientation plane. The orientation plane of the solar energy capture device is offset at an angle from the roll axis. The sensor can be an accelerometer.

In another embodiment, an apparatus for capturing solar energy includes a solar energy capture device having an of orientation plane, a frame for supporting the solar energy capture device, a joint connected to the solar energy capture device and the frame, and a sensor configured to determine the direction of gravity relative to a second plane. The joint is configured to allow rotation of the solar energy capture device about a roll axis and a pitch axis. The joint has a surface that has a fixed orientation relative to the solar energy capture device. The orientation plane of the solar energy capture device is offset from the orientation plane. The sensor is mounted to the surface of the joint that has the fixed orientation relative to the solar energy capture device. The sensor can be an accelerometer.

In one embodiment, a method for determining an orientation of a solar energy capture device having an orientation plane includes determining a direction of gravity relative to a second plane. The second plane has an orientation that is fixed relative to the orientation plane. The orientation plane is offset from the roll axis. The method also includes determining an orientation of the solar energy capture device based on the direction of gravity relative to the second plane.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIGS. 1A and 1B illustrate a schematic side view and a schematic perspective view, respectively, of an apparatus that determines and changes the orientation of a solar energy capture device at a desired orientation according to an embodiment of the present invention.

FIG. 2 depicts a block diagram of an apparatus that determines and changes the orientation of an object at a desired orientation according to an embodiment of the present invention.

FIG. 3 illustrates a perspective view of an apparatus that determines and changes the orientation of a solar energy capture device at a desired orientation according to an embodiment of the present invention.

FIG. 4 illustrates a schematic side view of an apparatus that determines and changes the orientation of a solar energy capture device at a desired orientation according to an embodiment of the present invention.

FIG. 5 illustrates a front perspective view of an apparatus that determines and changes the orientation of a solar energy capture device at a desired orientation according to an embodiment of the present invention.

FIG. 6 illustrates a rear perspective view of an apparatus that determines and changes the orientation of a solar energy capture device at a desired orientation according to an embodiment of the present invention.

FIG. 7 illustrates a schematic side view of an apparatus that determines or changes the orientation of a solar energy capture device at a desired orientation according to an embodiment of the present invention.

FIG. 8 illustrates a process flowchart depicting a method of determining and changing the orientation of a solar energy capture device according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

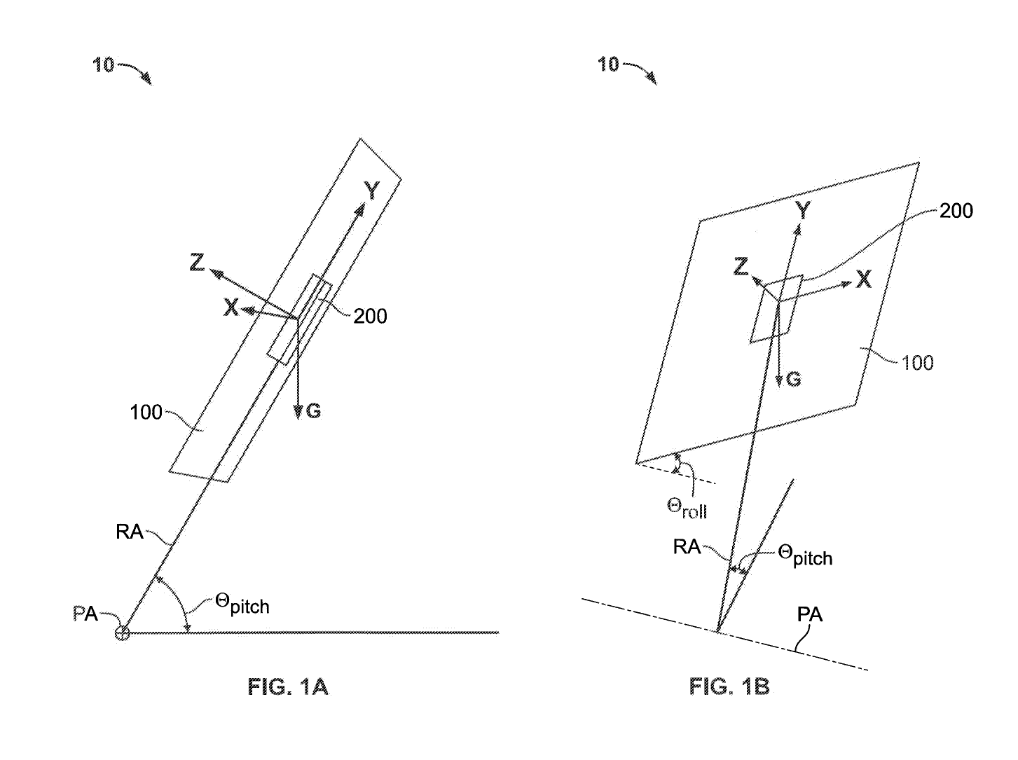

FIGS. 1A and 1B illustrate an apparatus 10 for determining and changing the orientation of an object 100. Object 100 can include any object having at least two desired orientations, for example, a solar energy capture device, a communication antenna, a weapons platform, a directed-energy appliance, or any other suitable object. In FIGS. 1-7 and the corresponding description, object 100 is a solar energy capture device. As shown in FIGS. 1A and 1B, the apparatus 10 includes solar energy capture device 100 and a sensor 200. In one embodiment, apparatus 10 has two-axis kinematics—for example, solar energy capture device 100 is configured such that it can rotate about a first axis and a second axis. In one embodiment, the first axis is a roll axis RA and the second axis is a pitch axis PA orientated 90° from roll axis RA. Sensor 200 measures acceleration along at least two axes.

As shown in FIG. 1, sensor 200 measures acceleration along three axes, for example, the X axis, Y axis, and Z axis. Accordingly, the direction of gravity G can be resolved relative to the X-Y plane, the X-Z plane, and the Y-Z plane. As shown in FIGS. 1A and 1B, solar energy capture device 100 is substantially planar such that it defines an orientation plane along the X axis and the Y axis. Accordingly, the plane of solar energy capture device 100 is parallel with the X-Y plane of sensor 200. Sensor 200 can be, for example, a 3-axis accelerometer.

Knowing that the direction of gravity G is vertical and that the Y axis of the orientation plane (the X-Y plane) of solar energy capture device 100 is aligned with roll axis RA, the pitch angle Θ_{pitch}—the angle between roll axis RA and the horizontal ground H—and the roll angle Θᵣₒₗₗ—the angle between pitch axis PA and the orientation plane—can be determined. Sensor 200 can resolve the direction of gravity relative to the X-Y plane to determine the angle between the roll axis RA and the direction of gravity G. The pitch angle Θ_{pitch} is equal to the angle between the roll axis RA and the direction of gravity G minus 90°.

To determine the roll angle Θᵣₒₗₗ, the cross product of the direction of gravity G and a unit vector along the Y axis is determined. The cross product is parallel to the horizontal ground H and orthogonal to roll axis RA because the Y axis is aligned with roll axis RA. The roll angle Θᵣₒₗₗ is equal to the angle between the Z axis and the cross product (of the direction of gravity and a unit vector along the Y axis) minus 90°.

One problem encountered, however, is that when solar energy capture device 100 is vertical, the direction of gravity G is aligned with the Y axis (and roll axis RA), so the cross product is zero, and the roll angle Θᵣₒₗₗ cannot be determined because azimuthal symmetry occurs—the direction of gravity relative to the orientation plane (the X-Y plane) never changes regardless of the roll angle Θᵣₒₗₗ. Further, accuracy is greatly reduced as solar energy capture device 100 (and its orientation plane) approaches the vertical orientation.

With two-axis kinematics, azimuthal symmetry occurs whenever one axis is vertical. Accordingly, azimuthal symmetry is always present with azimuth-elevation kinematics about the azimuth axis because the azimuth axis is vertically fixed. Similarly, degeneracy occurs when the combination of rotations about the two axes produces rotation about the vertical.

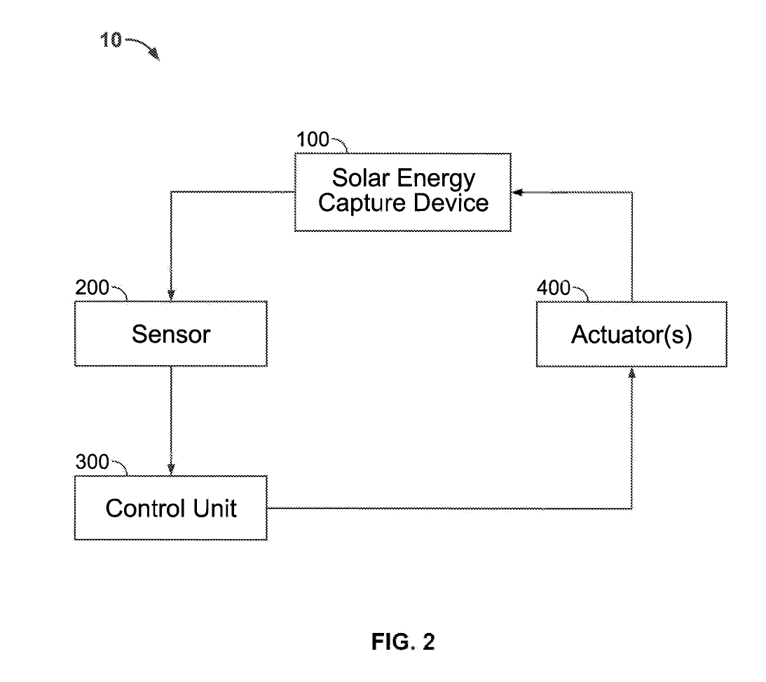

FIG. 2 is a block diagram of an apparatus 10 that determines and changes the orientation of an object 100, for example, a solar energy capture device 100, at a desired orientation according to an embodiment of the present invention. In one embodiment, apparatus 10 eliminates the azimuthal symmetry at or near the vertical orientation of solar energy capture device 100.

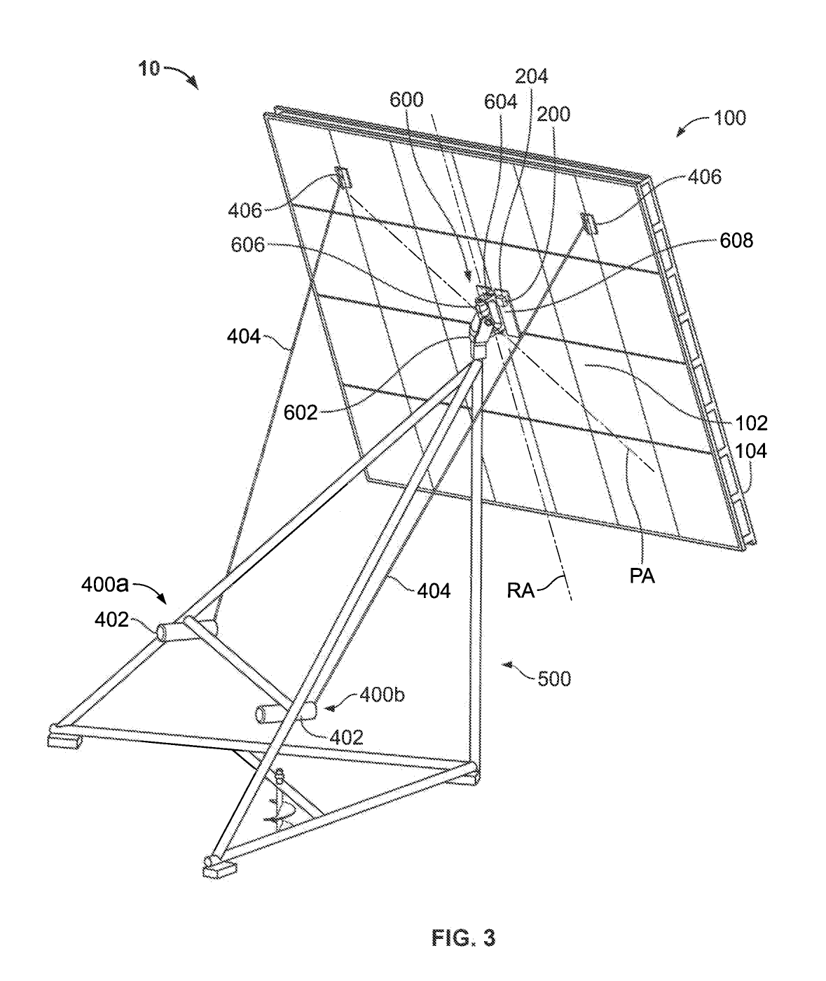

In one embodiment as shown in FIG. 2, apparatus 10 includes solar energy capture device 100, a sensor 200, a control unit 300, and actuator(s) 400. In some embodiments, solar energy capture device 100 may be a mirror assembly used with a solar thermal system or a photovoltaic panel used with a solar photovoltaic system. In one embodiment, solar energy capture device 100 is configured and arranged to rotate about a roll axis and a pitch axis as farther described below with reference to FIGS. 3-7.

The orientation of solar energy capture device 100 can be described relative to the direction of a vector normal to a plane (“orientation plane”) fixed relative to solar energy capture device 100. For example, in one embodiment, if solar energy capture device 100 is parabolic, the orientation of device 100 can be described by the direction of a vector normal to a plane that is tangent to the vertex of object 100. In another embodiment in which object 100 is substantially planar, for example, the orientation of object 100 can be described by the direction of a vector normal to the plane in which device 100 lies.

In an embodiment in which solar energy capture device 100 is substantially planar and the orientation plane is defined as the plane within which device 100 lies, it may be desirable to change the orientation of solar energy capture device 100 such that the normal vector of the orientation plane of solar energy capture device 100 bisects the angle between the incident light and a receiver in a solar thermal system. In another embodiment, it may be desirable to change the orientation of solar energy capture device 100 such that the normal vector of the orientation plane of solar energy capture device 100 is aligned with the angle of incident light from the sun in a photovoltaic system.

Apparatus 10 further includes sensor 200. Sensor 200 can resolve the direction of gravity relative to a plane (“sensor plane”). Sensor 200 and the sensor plane have an orientation that is fixed relative to the orientation of solar energy capture device 100. Sensor 200 can be mounted on apparatus 10 at any suitable location that is fixed relative to solar energy capture device 100, for example, directly to solar energy capture device 100, a surface of a joint that has a fixed orientation relative to solar energy capture device 100, or any other location that is fixed relative to solar energy capture device 100. Accordingly, as solar energy capture device 100 rotates about the roll axis and the pitch axis, sensor 200 and its sensor plane rotates about the roll axis and the pitch axis.

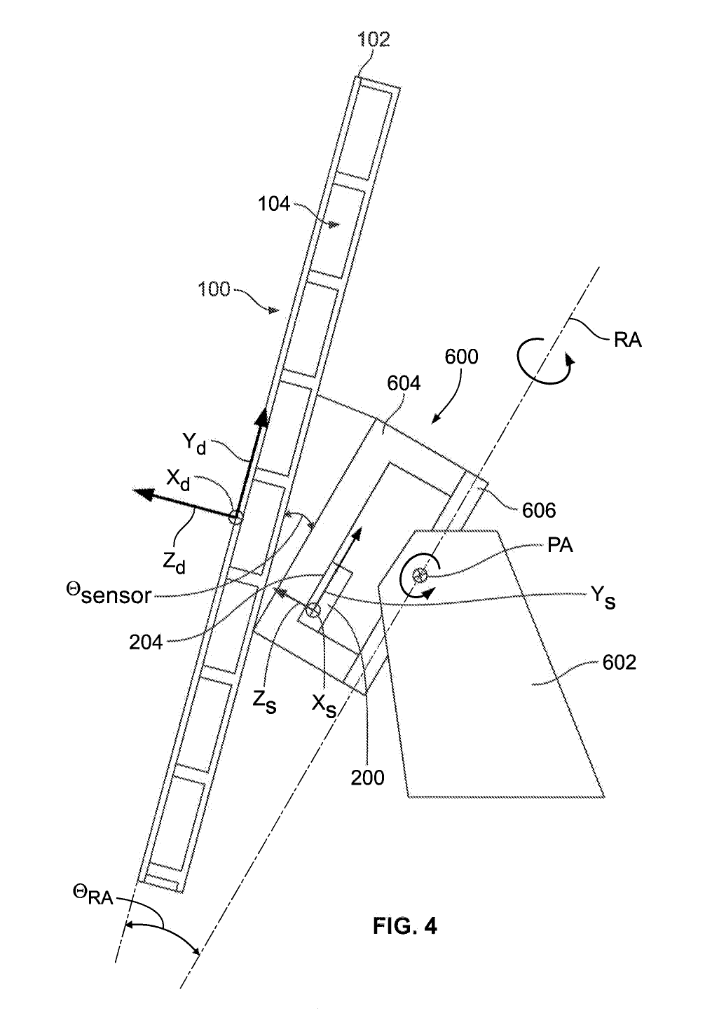

Sensor 200 can be any device capable of resolving the direction of gravity relative to a plane, for example, an accelerometer that can measure acceleration along two or more axes, or an inclinometer that can measure angles of an object with respect to gravity along two or more axes. In one embodiment, sensor 200 is a 3-axis accelerometer—an accelerometer capable of measuring acceleration along three axes, for example, the X, axis, the Yₛ axis, and the Zₛ axis as shown in FIGS. 4-7—and thus capable of resolving the direction of gravity relative to three planes—the Xₛ-Yₛ plane, the Xₛ-Zₛ plane, and the Yₛ-Zₛ plane. Sensor 200 can be any suitable accelerometer type, for example, capacitive, piezoelectric, piezoresistive, Hall effect, magnetoresistive, or any other suitable type. In one embodiment, sensor 200 can be an ADXL327 3-Axis, capacitive accelerometer produced by Analog Devices, Inc. In another embodiment, sensor 200 is a 2-axis accelerometer. In yet another embodiment, sensor 200 can be a two-axis inclinometer. In other embodiments, sensor 200 can be any suitable inclinometer type that uses, for example, gyroscopes, partially-liquid-filled cavities, pendulums, or other mechanisms.

In one embodiment, the sensor plane is aligned with an exterior surface of the sensor package. For example, the sensor plane may be parallel to the exterior surface of the sensor package. In another embodiment, the sensor plane is offset from the exterior surface of the sensor package.

In one embodiment in which sensor 200 is a 3-axis accelerometer, one axis of the sensor 200 that defines the sensor plane is parallel to the plane of solar energy capture device 100 having a normal vector with a desired alignment direction.

Control unit 300 includes a processor and memory. Control unit 300 is operatively connected to sensor 200 such that control unit 300 can determine the orientation of solar energy capture device 100 based on one or more output signals of sensor 200. Control unit 300 is also operatively connected to actuators(s) 400. Control unit 300 is adapted to generate and manipulate one or more control signals that cause actuator(s) 400 to change the orientation of solar energy capture device 100. In one embodiment, control unit 300 can be integrated with sensor 200, in another embodiment, control unit 300 can be a separate device from sensor 200.

Apparatus 10 can also include at least one actuator 400 coupled to solar energy capture device 100. Actuator(s) 400 can be adapted to change the orientation of solar energy capture device 100. Actuator(s) 400 can selectively apply a force to solar energy capture device 100 to change its orientation. In one embodiment, actuator(s) 400 can be linear actuators having a drive component, for example, a motor or hydraulic pump and cylinder, and a variable length member that can selectively change its length. Linear actuators can include, for example, a cable actuation mechanism including a motor and a cable, a hydraulic piston, a scissor-jack, a linear screw drive, or any other suitable linear actuator having a variable length member. In such embodiments, changing the length of the variable length member rotates solar energy capture device 100 about the pitch axis and the roll axis. In another embodiment, actuator(s) 400 can be motors directly coupled to members that rotate about the roll axis and the pitch axis.

In some embodiments, apparatus 10 may include two, three, or more than three actuators 400. In some embodiments, actuator(s) 400 can include one, two, three, or more than three linear actuators. Linear actuator(s) 400 coupled to solar energy capture device 100 may comprise the same type or different types of actuators. For example, in some embodiments, first and second linear actuators 400 may both comprise a cable-actuated mechanism. In other embodiments, for example, a first linear actuator 400 may comprise a cable actuator and a second linear actuator 400 may comprise a hydraulic piston actuator.

Apparatus 10 may be used as an individual unit for determining and changing the orientation of a single solar energy capture device 100 or as a series of units in an array for determining and changing the orientation of a plurality of solar energy capture devices 100. For example, in one embodiment, a plurality of apparatuses 10 each having a solar energy capture device 100 may be arranged in a solar field. In one embodiment such as a thermal system, the plurality of apparatuses 10 may be arranged to concentrate the reflected sunlight onto a receiver that powers a heat engine which, in turn, drives a rotary generator, for example, a turbine. In one embodiment, apparatuses 10 in an array can be arranged in one or more linear or arcuate rows.

In one embodiment, the orientation plane of solar energy capture device 100 having a normal vector with a desired alignment direction is offset at an angle from roll axis RA. When offset at an angle, the orientation plane can intersect the roll axis RA. For example, the top edge of a substantially planar solar energy capture device 100 can be further away from roll axis RA than the bottom edge of solar energy capture device 100. Accordingly, when roll axis RA is vertical, the normal vector of the orientation plane of solar energy capture device 100 is pointing below the horizon. Further, when solar energy capture device 100 is orientated in a vertical position, roll axis RA is not aligned with the direction of gravity. Thus, rotation about roll axis RA can be determined because azimuthal symmetry does not exist at this orientation. In one embodiment, azimuthal symmetry will not occur at any operable orientation of solar energy capture device 100. In another embodiment, azimuthal symmetry will not occur until solar energy capture device 100 is rotated about the pitch axis to an orientation beyond the vertical orientation such that the normal vector is pointing below the horizon.

In one embodiment, the angle of offset between the orientation plane of solar energy capture device 100 having a normal vector with a desired alignment direction and roll axis RA is between about 5° and about 25°. In another embodiment, the offset angle is between about 10° and about 20°. In another embodiment, the offset angle is about 15°. In other embodiments, the offset angle can be less than about 5° or more than about 25°. In some embodiments, offset angle can be any angle that places the azimuthally symmetric orientation (with roll axis RA being vertical) beyond the useful range of solar energy capture device 100.

In some embodiments, the offset angle can be 0°. For example, the offset angle between the orientation plane of solar energy capture device 100 and roll axis RA can be 0° when the vertical orientation of the orientation plane of solar energy capture device 100 is well beyond the operable range of apparatus 10, for example, an operable range that does not require roll axis RA to approach its vertical orientation.

FIG. 3 illustrates a rear perspective view of apparatus 10 according to an embodiment. In one embodiment as shown in FIG. 3, apparatus 10 may also include a frame 500 and a joint 600. Frame 500 is adapted to structurally support and to change the orientation of solar energy capture device 100. Frame 500 can be configured to directly or indirectly contact a mounting surface, for example, the ground, a roof, a wall, an overhead surface, or other suitable surface. Frame 500 elevates solar energy capture device 100 above the mounting surface. Frame 500 can be made of any suitable rigid material having sufficient strength to support solar energy capture device 100. For example, frame 500 can be formed from square tubing, piping, or channel made of iron, aluminum, composites (e.g., carbon fiber composites), wood, plastic, or any other suitable material.

Joint 600 rotatably couples solar energy capture device 100 to frame 500 such that solar energy capture device 100 can rotate relative to frame 500. In one embodiment, joint 600 defines pitch axis PA and roll axis RA. For example, as shown in FIG. 4, as solar energy capture device 100 rotates in one direction about pitch axis PA, a top edge 102 of solar energy capture device 100 moves away from joint 600 in a forward direction, and as solar energy capture device 100 rotates in the other direction about pitch axis PA, top edge 102 moves towards joint 600 in a backwards direction. Further for example, as solar energy capture device 100 rotates in one direction about roll axis RA, a left edge 104 of solar energy capture device 100 moves away from joint 600 in a forward direction, and as solar energy capture device 100 rotates in the other direction about roll axis RA, left edge 104 moves towards joint 600 in a backwards direction. When coupled to joint 600, solar energy capture device 100 can rotate about pitch axis PA and roll axis RA. Joint 600 can be a universal joint (U-joint), a ball and socket joint, or any other type of joint that has two degrees of freedom. In one embodiment, joint 600 can be made of one or more rotating members.

In one embodiment as shown in FIGS. 3-7, joint COO is a U-joint that allows solar energy capture device 100 to rotate in any direction relative to frame 500 (about roll axis RA and pitch axis PA). U-joint 600 includes a lower yoke 602 and an upper yoke 604. Lower yoke 602 couples joint 600 to frame 500, for example, at a top portion of frame 500. Upper yoke 604 couples joint 600 to solar energy capture device 100, for example, by interfacing with attachment plate 608 coupled to back surface 102 of solar energy capture device 100. In other embodiments, upper yoke 604 may connect directly to solar energy capture device 100. Lower yoke 602 and upper yoke 604 are rotatably coupled together by center portion 606.

Upper yoke 604 can be coupled to attachment plate 308. Attachment plate 608 is securely coupled to back surface 102 of solar energy capture device 100 using any suitable adhesive or any suitable fasteners. In one embodiment, solar energy capture device is coupled to joint 600 such that an orientation plane of solar energy capture device 100 is offset from roll axis RA.

In one embodiment, as shown, for example, in FIG. 3, lower yoke 602 is adapted to allow rotation of solar energy capture device 100 about pitch axis PA, and upper yoke 604 is adapted to allow rotation of solar energy capture device 100 about roll axis RA. In this manner, upper yoke 604 may be positioned intermediate to solar energy capture device 100 and lower yoke 602, and lower yoke 602 may be positioned intermediate to upper yoke 604 and frame 500. The relative orientation of upper yoke 604 and lower yoke 602 permits stable rotation of device 100 relative to frame 500.

In another embodiment, sensor 200 may be coupled to attachment plate 608 of joint 600, which is coupled to solar energy capture device 100. Accordingly, the sensor plane of sensor 200 rotates about pitch axis PA and roll axis RA as solar energy capture device 100 rotates about these same axes. The orientation plane of substantially planar solar energy capture device 100 having a normal vector with a desired orientation can be offset at an angle from roll axis RA. Accordingly, when solar energy capture device 100 is oriented such that it is substantially vertical, roll axis RA is not substantially vertical and, thus, not parallel to the direction of gravity, preventing azimuthal symmetry at this vertical orientation of solar energy capture device 100.

With reference to FIG. 3, in one embodiment apparatus 10 also includes a first linear actuator 400a and a second linear actuator 400b. Each linear actuator 400a and 400b has a variable length member coupled to solar energy capture device 100. In one embodiment, first and second linear actuators 400a and 400b each comprise a cable actuation mechanism including a motor 402 and a cable 404. Motor 402 can be any suitable motor that can rotate a spool in one direction to spool cable 404 on the spool, which decreases the length of the variable length member, and can rotate the spool in an opposite direction to release cable 404 from the spool, which increases the length of the variable length member. The distal end of left cable 404 is coupled to solar energy capture device 100 near its left edge, and the distal end of right cable 404 is coupled to solar energy capture device 100 near its right edge. Cables 404 can be coupled to solar energy capture device 100 using mounting brackets. Each cable 404 can be looped around a mounting pin on a mounting bracket 406.

Apparatus 10 may further include a control unit 300 (not shown in FIG. 3) for operating linear actuators 400a and 400b. During operation, control unit 300 is adapted to send one or more control signals to linear actuators 400a and 400b. To rotate solar energy capture device 100 about pitch axis PA, control unit 300 collectively actuates linear actuators 400a and 400b. To rotate solar energy capture device 100 about roll axis RA, control unit 300 differentially actuates linear actuators 400a and 400b. Accordingly, the pitch angle and the roll angle of solar energy capture device 100 can be changed by a combination of collectively and/or differentially actuating linear actuators 400a and 400b.

FIG. 4 illustrates a schematic side view of apparatus 10 according to another embodiment. In one embodiment as illustrated in FIG. 4, sensor 200 is coupled to a lower surface of upper yoke 604 of joint 600 by any suitable attachment mechanism, for example, by using any suitable adhesive or suitable fasteners. Upper yoke 604 is securely coupled to solar energy capture device 100. Accordingly, as solar energy capture device 100 rotates about pitch axis PA and roil axis RA, upper yoke 604, as well as sensor 200, rotates about the same axes. As shown in FIG. 4, sensor 200 can be a 3-axis accelerometer that can resolve the direction of gravity along axis Xₛ, axis Yₛ, and axis Zₛ.

As shown in FIG. 4, the orientation plane (defined by axis X_{d} and axis Y_{d} in the illustrated embodiment) of solar energy capture device 100 having a normal vector that has a desired alignment direction is offset from roll axis. The orientation plane can be offset by an angle Θ_{RA}. In one embodiment, angle Θ_{RA} can be between about 5° and about 25°. In another embodiment, the angle Θ_{RA} can be between about 10° and about 20°. In another embodiment, the angle Θ_{RA} can be about 15°. In other embodiments, angle Θ_{RA} can be less than about 5° or more than about 25°. In some embodiments, angle Θ_{RA} can be 0°. In some embodiments, angle Θ_{RA} can be any angle that places the azimuthally symmetric orientation beyond the useful range of solar energy capture device 100. In one embodiment, the offset angle Θ_{RA} can be achieved by angling solar energy capture device 100 from upper yoke 604 of joint 600. In one embodiment, sensor 200 is angled relative to solar energy capture device 100 by offset angle Θₛₑₙₛₒᵣ. In one embodiment, sensor 200 is oriented relative to solar energy capture device 100 such that the coordinate systems (Xₛ, Yₛ, Zₛ) and (X_{d}, Y_{d}, Z_{d}) are related by a constant mathematical operation R, which could be a rotation, an improper rotation, a linear transformation, or an affine transformation.

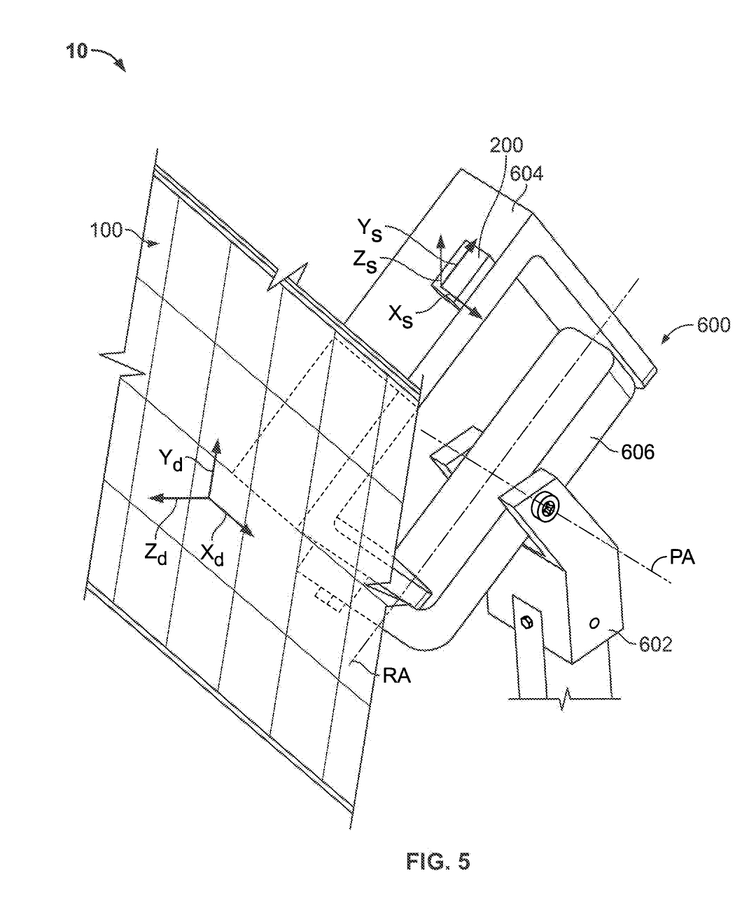

FIG. 5 is a front perspective view of apparatus 10 according to an embodiment with portion of solar energy capture device 100 cut away. In one embodiment as shown in FIG. 5, sensor 200 is mounted to an upper surface of upper yoke 604 of joint 600. Solar energy capture device 100 is fixedly coupled to upper yoke 604. Solar energy capture device 100 can rotate about pitch axis PA and roll axis RA. Because sensor 200 is mounted to upper yoke 604, a sensor plane, for example, the Xₛ-Yₛ plane, rotates about pitch axis PA and roll axis RA along with solar energy capture device 100.

As shown in FIG. 5, the orientation plane (defined by axis X_{d} and axis Y_{d}) of solar energy capture device 100 having a normal vector with a desired alignment direction is offset at an angle from roll axis RA. Accordingly, when solar energy capture device 100 is substantially vertical, the roll axis RA is not aligned with the direction of gravity because the orientation plane is offset at an angle from roll axis RA. Accordingly, azimuthal symmetry does not does not occur at this vertical orientation of solar energy capture device 100.

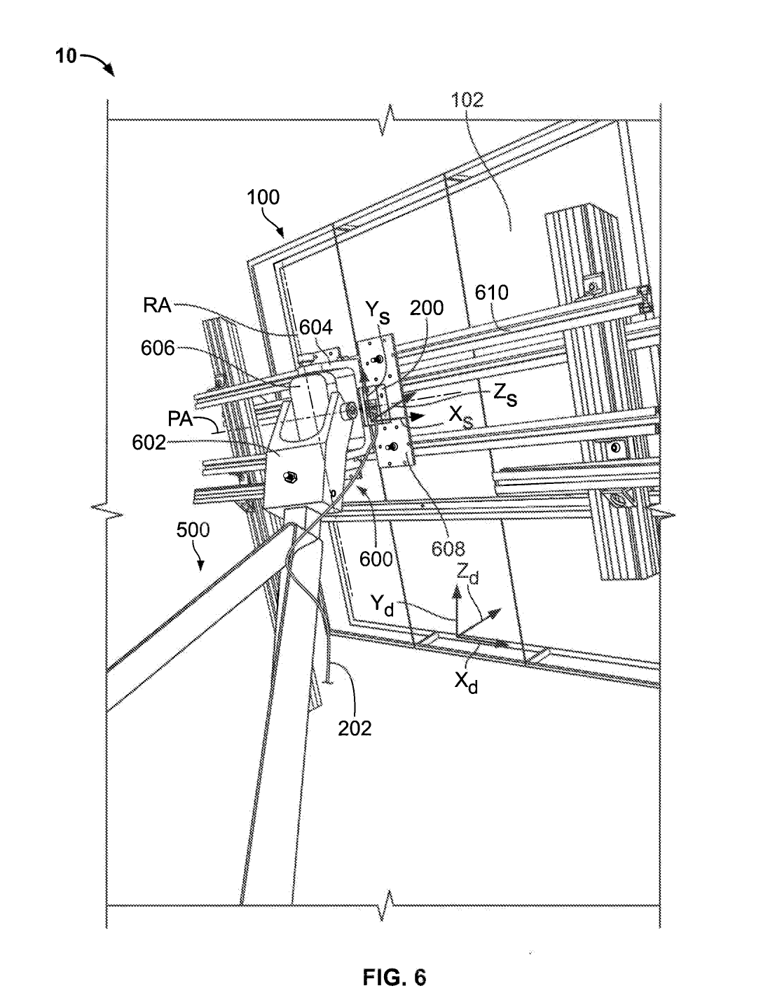

FIG. 6 illustrates a back perspective view of apparatus 10 according to an embodiment of the present invention. In one embodiment as shown in FIG. 6, apparatus 10 includes solar energy capture device 100, sensor 200, frame 500, and joint 600. Joint 600 is a U-joint including lower yoke 602, center portion 606, and upper yoke 604. Upper yoke 604 interfaces with attachment plate 608. Attachment plate 608 is securely coupled to intermediate bracing support 610. Intermediate bracing support 610 couples attachment plate 608 to solar energy capture device 100. Bracing 610 can angle solar energy capture device 100 relative to attachment plate 608. Sensor 200 can be coupled to attachment plate 608. Sensor 200 can be a three-axis accelerometer that can resolve the direction of gravity along axis Xₛ axis Yₛ, and axis Zₛ. In other words, sensor 200 can resolve the direction of gravity relative to the Xₛ-Yₛ plane, the Xₛ-Zₛ plane, and the Yₛ-Zₛ plane. Sensor 200 can also include signal wire 202. Signal wire 202 can be operatively connected to control unit 300 (not shown in FIG. 6).

Because bracing 610 angles solar energy capture device 100 relative to attachment plate 608, the orientation plane (the X_{d}-Y_{d} plane as illustrated) of solar energy capture device 100 is offset from roll axis RA. Consequently, when solar energy capture device 100 is substantially vertical, the roll axis RA is not substantially vertical. Thus, the direction of gravity will not be parallel to roll axis RA, and azimuthal symmetry does not occur at this orientation.

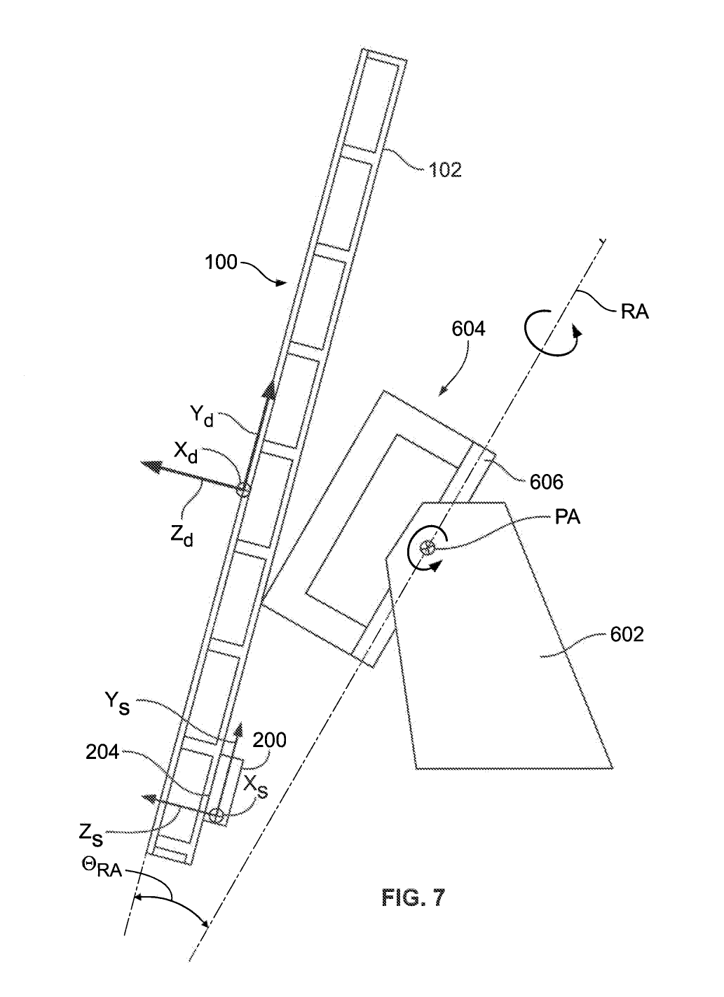

FIG. 7 illustrates a side schematic view of apparatus 10 according to an embodiment. In one embodiment as shown in FIG. 7, apparatus 10 includes solar energy capture device 100, sensor 200, and joint 600. Joint 600 can be a U-joint including lower yoke 602, center portion 606, and upper yoke 604. Lower yoke 602 can be configured to couple to frame 500 (not shown in FIG. 7). Joint 600 can be configured to rotate solar energy capture device 100 about roll axis RA and pitch axis PA. Solar energy capture device 100 is fixedly coupled to upper yoke 604. Solar energy capture device 100 may be angled relative to the upper surface of upper yoke 604 to create an offset between the orientation plane (the X_{d}-Y_{d} plane as illustrated) of solar energy capture device 100 and roll axis RA.

As shown in FIG. 7, in one embodiment, sensor 200 can be coupled directly to solar energy capture device 100 by using any suitable attachment mechanism, for example, any suitable adhesive or suitable fasteners. Sensor 200 can be a 3-axis accelerometer that measures acceleration along axis Xₛ, axis Yₛ, and axis Zₛ. In one embodiment, the orientation plane (the X_{d}-Y_{d} plane as illustrated) is offset at an angle relative to roll axis RA by offset angle Θ_{RA}. Offset angle Θ_{RA} can be between about 5° and about 25°. In one embodiment, offset angle Θ_{RA} can be between about 10° and about 20°. In another embodiment, offset angle Θ_{RA} can be about 15°. As shown in FIG. 7, package surface 204 of sensor 200 is flush with back surface 102 of solar energy capture device 100. As such, in one embodiment, sensor 200 is not angled relative to solar energy capture device 100 by offset angle Θₛₑₙₛₒᵣ. In other embodiments (not shown), sensor 200 may be angled relative to solar energy capture device 100 by offset angle Θₛₑₙₛₒᵣ. Offset angle Θₛₑₙₛₒᵣ can be between about 5° and about 25°. In one embodiment, offset angle Θₛₑₙₛₒᵣ can be between about 10° and about 20°. In another embodiment, offset angle Θₛₑₙₛₒᵣ can be about 15°.

Solar energy capture device 100 can have a plane, for example, defined by axis Y_{d} and axis X_{d}, having a normal vector with a desired alignment direction. Accordingly, when solar energy capture device 100 is substantially vertical and axis Z_{d} is substantially horizontal, roll axis RA is not vertical and thus not aligned with the direction of gravity, preventing azimuthal symmetry about roll axis RA.

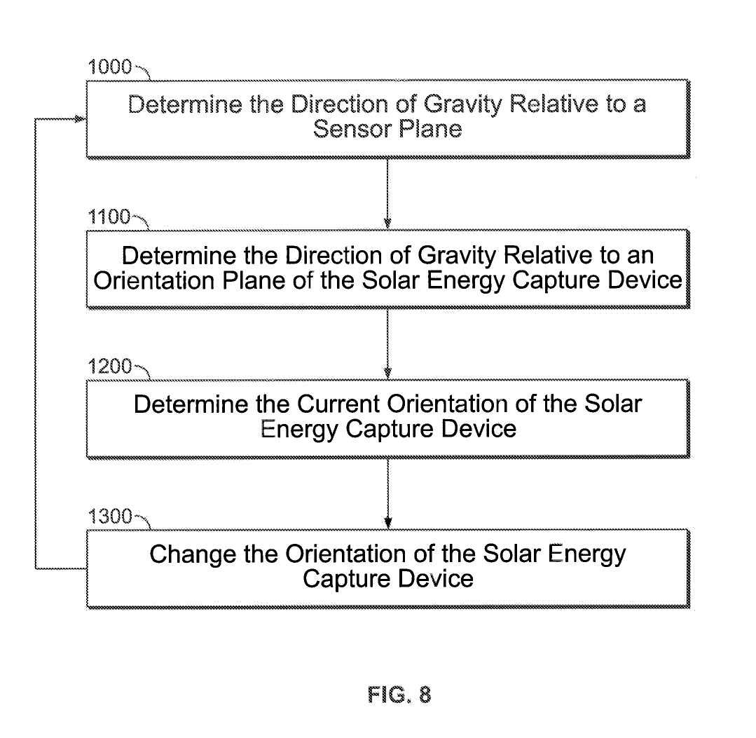

FIG. 8 is a block diagram that illustrates a method of determining and changing the orientation of solar energy capture device 100 that is configured to rotate about roll axis RA and pitch axis PA according to an embodiment. In step 1000, the direction of gravity relative to a sensor plane is determined using sensor 200. For example, sensor 200 can resolve the direction of gravity relative to sensor plane Xₛ-Yₛ as described above with reference to FIGS. 4-7.

At step 1100, the direction of gravity relative to an orientation plane of solar energy capture device 100 can be determined. For example, the direction of gravity relative to the orientation plane (e.g., the X_{d}-Y_{d} plane as shown in FIGS. 4-7) can be determined by using a known relationship between the sensor plane (e.g., the Xₛ-Yₛ plane as shown in FIGS. 4-7) and the orientation plane, including for example, a known offset angle Θₛₑₙₛₒᵣ or a known mathematical operation R between the orientation plane and the sensor plane.

At step 1200, the current orientation of solar energy capture device 100 is determined. For example, the pitch angle and the roll angle of solar energy capture device 100 can be determined by using the direction of gravity relative to the orientation plane determined at step 1100 and a known offset angle Θ_{RA} between the orientation plane and the roll axis RA. In one embodiment, the direction of the vector normal to the orientation plane can be determined using the determined pitch and roll angles. The determined direction of the normal vector can be used to characterize the current orientation of solar energy capture device 100.

At step 1300, the orientation of solar energy capture device 100 is changed based on the determined current orientation of solar energy capture device 100. In one embodiment, the orientation of solar energy capture device 100 is changed by collectively actuating the first and second actuators to rotate the solar energy capture device 100 about the pitch axis and by differentially actuating the first and second actuators to rotate the solar energy capture device about the roll axis.

In one embodiment at step 1300, the orientation of solar energy capture device 100 is changed to a desired orientation. In some embodiments, the desired orientation is based on the current position of the sun, which can be determined by known orbital patterns determined by date. As will be appreciated, the current position of the sun may be determined by one or more data elements including, but not limited to, date, time, and geographic location (e.g., latitude and longitude coordinates). In another embodiment, the position of the sun is determined by using a sensor. Using the current position of the sun, a desired orientation of the solar energy capture device 100 can be determined. For example, if solar energy capture device 100 is a mirror assembly for a thermal system, the desired orientation can be one that positions the mirror assembly so that the reflected light is focused on a receiver. If solar energy capture device 100 is a photovoltaic panel, the desired orientation can be, for example, an orientation that positions the photovoltaic panel to be perpendicular to the incident light from the sun.

In other embodiments, the orientation of solar energy capture device 100 is changed to a desired orientation based on weather conditions. Sensor 200 can determine the current orientation of solar energy capture device 100 during orientation changes based on the weather conditions. For example, a substantially planar solar energy capture device 100 can be positioned at a vertical hail-safe orientation to minimize damage to solar energy capture device 100 during a hail storm. Solar energy capture device 100 can be positioned at a wind-safe orientation that minimizes the wind resistance of solar energy capture device 100 during periods of strong winds. For example, a substantially planar solar energy capture device 100 can be moved to a vertical orientation in which the plane of solar energy capture device 100 is substantially parallel to the direction of the wind. In one embodiment, weather conditions are detected using meteorological measuring devices. In other embodiments, weather conditions are predicted using computerized meteorological models, and the timing of the orientation changes is based on the meteorological predictions.

In yet another embodiment, the orientation of solar energy capture device 100 is changed to a desired orientation for maintenance operations during which sensor 200 determines the current orientation of solar energy capture device 100. For example, solar energy capture device 100 can be positioned at an orientation that creates user access to the front surface of solar energy capture device 100 for washing or for repair, or solar energy capture device 100 can be positioned at an orientation for stowing.

In one embodiment, control unit 300 performs steps 1000-1200 and controls step 1300. Sensor 200 can provide real time direction of gravity information to control unit 300, allowing for real time determination of solar energy capture device 100 orientation and for desired orientation changes.

In some embodiments, the method is repeated after a predetermined time interval, for example, every thirty minutes, every hour, every other hour, or any other suitable time interval. In some embodiments, the orientation of solar energy capture device 100 is continuously updated in real-time.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. For example, although the figures illustrate the device 100 as a solar energy capture device, apparatus 10 can be adapted to determine and change the orientation of other objects such as communication antennas, weapon platforms, and directed-energy appliances, for example. Therefore, such adaptations and modifications are intended to be within the meaning and range of equivalents of the disclosed embodiments, based on the teaching and guidance presented herein.

It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. An apparatus for capturing solar energy, comprising:
a solar energy capture device having an orientation plane, wherein the solar energy capture device is configured to rotate about a pitch axis and a roll axis, the orientation plane being offset at an angle from the roll axis; and
a sensor configured to determine a direction of gravity relative to a sensor plane, the sensor plane having an orientation that is fixed relative to the solar energy capture device.

2. The apparatus of claim 1, wherein the solar energy capture device is substantially planar, and is coplanar with the orientation plane.

3. The apparatus of claim 1, wherein the sensor comprises an accelerometer having a first axis and second axis that define the sensor plane.

4. The apparatus of claim 1, wherein the sensor is an inclinometer.

5. The apparatus of claim 1, wherein the solar energy capture device is a mirror assembly.

6. The apparatus of claim 1, wherein the sensor is mounted on the solar energy capture device.

7. The apparatus of claim 1, wherein the angle of offset is between about 5 degrees and about 25 degrees.

8. An apparatus for capturing solar energy, comprising:
a solar energy capture device having an orientation plane;
a frame for supporting the solar energy capture device;
a joint connected to the solar energy capture device and the frame to allow rotation of the solar energy capture device about a roll axis and a pitch axis, the joint having a surface that has a fixed orientation relative to the solar energy capture device; and
a sensor configured to determine the direction of gravity relative to a sensor plane.

9. The apparatus of claim 8, wherein the sensor is mounted to the surface that has the fixed orientation relative to the solar energy capture device.

10. The apparatus of claim 8, wherein the orientation plane is offset at an angle from the roll axis.

11. The apparatus of claim 8, wherein the solar energy capture device is substantially planar and is coplanar with the orientation plane.

12. The apparatus of claim 8, wherein the sensor comprises an accelerometer having a first axis and a second axis that define the sensor plane.

13. The apparatus of claim 8, wherein the solar energy capture device is a mirror assembly.

14. The apparatus of claim 8, wherein the joint comprises a universal joint having a lower yoke configured to couple to the frame, and an upper yoke rotatably coupled to the lower yoke such that the upper yoke can rotate about the roll axis and the pitch axis.

15. A method for determining the orientation of a solar energy capture device having an orientation plane and configured to rotate about a roll axis and a pitch axis, comprising:
determining a direction of gravity relative to a sensor plane, the sensor plane having an orientation that is fixed relative to the orientation plane; and
determining the orientation of the solar energy capture device based on the direction of gravity relative to the sensor plane.

16. The method of claim 15, wherein the orientation plane is offset at an angle from the roll axis.

17. The method of claim 15 further comprising changing the orientation of the solar energy capture device based on the determined orientation of the solar energy capture device.

18. The method of claim 17, wherein changing the orientation of the solar energy capture device is based on a position of the sun.

19. The method of claim 17, wherein changing the orientation of the solar energy capture device is based on weather conditions.

20. The method of claim 17, wherein changing the orientation of the solar energy capture device comprises moving the solar energy capture device from a first orientation to a second orientation after a predetermined time period.

21. An apparatus for capturing solar energy, comprising:
a solar energy capture device having an orientation plane, wherein the solar energy capture device is configured to rotate about a pitch axis and a roll axis; and
a sensor configured to determine a direction of gravity relative to a sensor plane, the sensor plane having an orientation that is fixed relative to the solar energy capture device.

22. The apparatus of claim 21, wherein the sensor is an accelerometer.

23. The apparatus of claim 22, wherein the accelerometer can measure acceleration along three axes.

24. The apparatus of claim 21, wherein the sensor is an inclinometer.
